(19) United States
(12) Patent Application Publication
(10) Pub. No.: US 2013/0304727 A1
(43) Pub. Date: Nov. 14, 2013

(54) METHOD AND SYSTEM FOR MANAGING SOCIAL NETWORK DATA

(71) Applicant: Joseph Shu Yan Poon, North Point (HK)

(72) Inventor: Joseph Shu Yan Poon, North Point (HK)

(21) Appl. No.: 13/891,082

(22) Filed: May 9, 2013

Related U.S. Application Data
(60) Provisional application No. 61/645,790, filed on May 11, 2012.
(60) Provisional application No. 61/649,538, filed on May 21, 2012.

(51) Int. Cl. H04L 12/58; G06F 17/30

(52) U.S. Cl. CPC H04L 51/32; G06F 17/30477
USPC 707/722; 709/205

(57) ABSTRACT

The present disclosure includes a method for social network management that includes receiving first network connectivity data associated with one or more posting user profiles, receiving posting content associated with one or more of the posting user profiles, receiving posing criteria associated with the posting content and at least one of the posting user profiles, generating a selective posting for at least one of the one or more posting user profiles, the selective posting having access or distribution properties different than a default posting and generated based on the posting criteria and the first network connectivity data and implementing the selective posting on at least one of the posting user profiles.

The present application is related to, and claims priority to, U.S. provisional patent application 61/645,790 filed May 11, 2012 and U.S. provisional patent application 61/649,538 filed May 21, 2012. Both applications are hereby incorporated by reference in their entirety for all purposes.

### TECHNICAL FIELD

The present disclosure relates generally to social networks and more particularly, but not exclusively, to systems and methods for providing a social network management system.

### BACKGROUND

Aspects of the present disclosure relate in general to management of information flows, and more particularly, to management of connections and information flows among individuals and organizations across various social networks using advanced analytical techniques.

Social networking brings individuals and organizations (collectively, “users”) together, establishes social connections and facilitates communications among users. Such social connections may be based on belonging to common institutions, circumstances, friendships, family relationships, business relationships and the like. Many social networking services allow users to publish identification information to establish a profile that is visible to other users. A user's profile may be made public or be limited to certain other users as determined by the user's preferences.

The widespread worldwide acceptance of social networking (online services such as Facebook and traditional establishments such as alumni associations) has effectively identified millions of individuals and organizations and mapped the relationships among them. Most social networks have measures to ensure the connections among individuals are genuine; for example, users are discouraged from establishing connections, or “friending,” people they do not know in person in an online social networking, and users have to obtain certain qualifications to belong to a traditional establishment. Thus users are reasonably assured of the identity of the other users on these social networks.

Some online social network services, such as Facebook, allow third-party computer applications to access and gather information about the connections of the users, (i.e. the “friend list” of a Facebook user and the “connections” of a LinkedIn user), after the users have given such consent to the operators of the third-party computer applications.

### BRIEF DESCRIPTION OF THE DRAWINGS

FIG. 1 is an exemplary top-level drawing illustrating an embodiment of a social network management system.

FIG. 2 is an exemplary data flow diagram illustrating an embodiment of a data flow path between the user device, social network server, and channel management system of FIG. 1.

FIG. 3 is an exemplary block diagram illustrating an embodiment of a method for social network posting management in accordance with an embodiment.

FIG. 4 is an exemplary data flow diagram illustrating an embodiment of a data flow path between the user device, social network server, and channel management system of FIG. 1.

FIG. 5 is an exemplary block diagram illustrating an embodiment of a method for social network search query management in accordance with an embodiment.

FIG. 6 is a diagram showing an illustrative user interface for a social network service.

FIG. 7 is a diagram showing an illustrative example for a user interface of the channel management system of FIG. 1, according to one embodiment of principles described herein.

FIG. 8 is a diagram showing an illustrative example for a user interface of the channel management system, according to one embodiment of principles described herein.

FIG. 9 is a diagram showing an illustrative example for a user interface of the channel management system, according to one embodiment of principles described herein.

FIG. 10 is a diagram showing an illustrative example for a user interface of the channel management system, according to one embodiment of principles described herein.

FIG. 11 is an example of a translation and formulation result from an operation reader, according to one embodiment of principles described herein.

FIG. 12 is an example of a translation and formulation result from an operation reader, according to one embodiment of principles described herein.

FIG. 13 is a diagram showing an illustrative presentation of a method of a channel management system, according to one embodiment of principles described herein.

FIG. 14 is a diagram showing an illustrative presentation of a method that the channel management system may use for an exclusion function, according to one embodiment of principles described herein.

FIG. 15 is a diagram showing an illustrative channel management system, according to one embodiment of principles described herein.

FIG. 16 is a table showing illustrative examples for conversion of the criteria to logical instructions, according to one embodiment of principles described herein.

### DETAILED DESCRIPTION

The present specification discloses methods and systems for establishing and managing social connections and information flows based on certain defined logical operations relating to users of social networks.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of the computer readable storage medium may include, but is not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present disclosure may be written in an object oriented programming language such as PHP, Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider), or the connection may be made through wireless network (including, but not limited to, WiFi, 3G and 4G network).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Throughout this specification and in the appended claims, the term “system” is to be broadly interpreted as a set of physical hardware operating according to software instructions. The term “users” is to be broadly interpreted as individuals, organizations, companies, institutions, Web sites and other online media accessing computing services via any medium. The term “social network” is to be broadly interpreted as a number of users or organizations forming an online community. The group may include users and organizations from the same social network service or multiple social networking services. The term “online media” is to be broadly interpreted as Web sites with a primary objective to provide information to the users. The term “internet-based services” is to be broadly interpreted as Web sites that have a primary objective of providing products and services to the users.

Throughout this specification and in the appended claims, the term “channel management system” is to be broadly interpreted as a set of physical hardware operating according to software instructing the hardware to manage or select individual users in social networks. The term “user database” is to be broadly interpreted as system for storage of user information. The term “logical operator” is to be broadly interpreted as a system which may process rules and make logical inferences. An “operation reader” is to be broadly interpreted as a system converting user defined instructions into certain logical operation instructions.

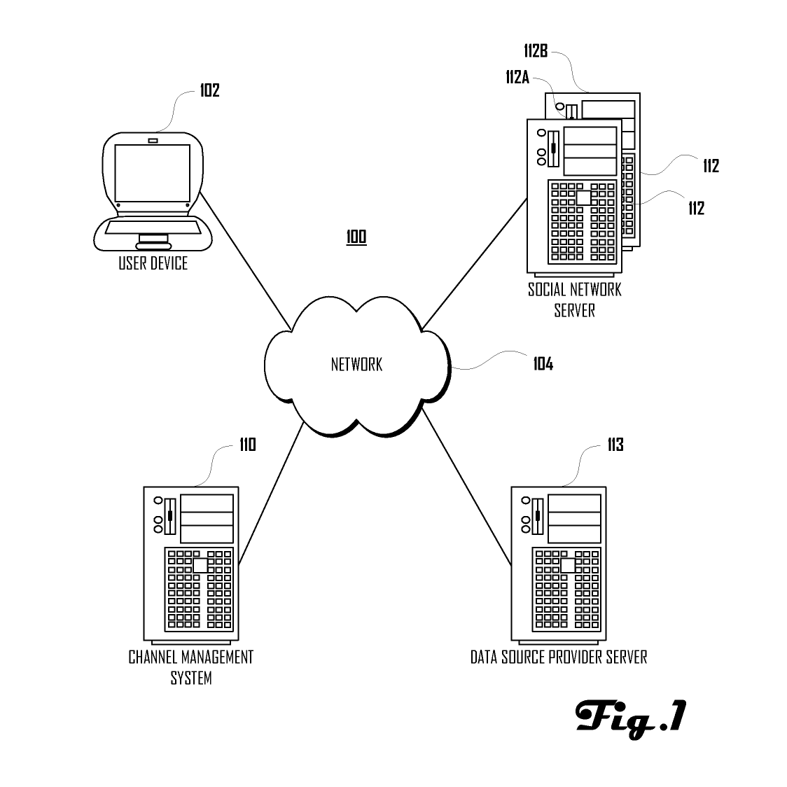

Turning to FIG. 1, the social network management system 100 is shown as including a user device 102, a channel management system 110, one or more social network serverss 112, and a data source provider server 113, that are operably connected via a network 104.

The user device 102 is depicted as a laptop computer as an example only, and in various embodiments, the user device 104 may be any suitable device including a smart phone, desktop computer, tablet computer, gaming device, server, or the like without limitation. Additionally, the servers 110, 112, 113 may be any suitable device or may comprise a plurality of devices, or may be a cloud-based system.

In some embodiments, one or more of the servers 110, 112, 113 may be the same device or related devices. For example a first social network server 112A may be associated with the Facebook social network, and a second social network server 112B may be associated with the LinkedIn social network. The first social network server 112A may comprise a device operable to, or itself be operable to, perform the function of a channel management system 110 as discussed in more detail herein. The second social network server 112B may comprise a device operable to, or itself be operable to, perform the function of a data source provider server 113 as discussed herein. Additionally, a social network server 112 may comprise a device operable to, or itself be operable to, perform the functions of both the channel management system 110 and the data source provider server 113.

Additionally, in various embodiments, there may be a plurality of the devices and servers 102, 110, 112, 113. For example, a plurality of users may each be associated with one or more user devices 102, and interact with a plurality of social networks via social network servers 112 associated with such social networks. Social networks may include Facebook, LinkedIn, Google+, Pinterest, or the like, without limitation. Users may have one or more profile on one or more of these social networks, and access, modify and receive notifications regarding these profiles via their user device 102. As is well known in the art, users can associate their profiles with the profiles of other users such that these associated users become “friends,” “links,” “connections” or the like. Being associated with another user's profile may allow for these associated users to view each other's profiles, correspond with each other, receive updates regarding the associated user, and the like.

Data source providers 113 may include, but are not limited to, social networking services, online news services, a blogging service or website, location-based information, a micro-blogging service (e.g., Twitter) or website, and customized source providers. In some embodiments, data source provider servers 113 and social network servers 112 may be the same or related servers.

As discussed in further detail herein, the channel management system 110 may allow a user to control, manage or regulate their user profile including controlling which users receive, or have access to, which information or content, which users receive correspondence or other content posted or broadcast by the sending user, and the like. Such functions may be in addition to, or act in cooperation with functionalities which may be available on a social media network.

In various embodiments, the network 104 may comprise one or more suitable wireless or wired network, including the Internet, a local-area network (LAN), a wide-area network (WAN), or the like.

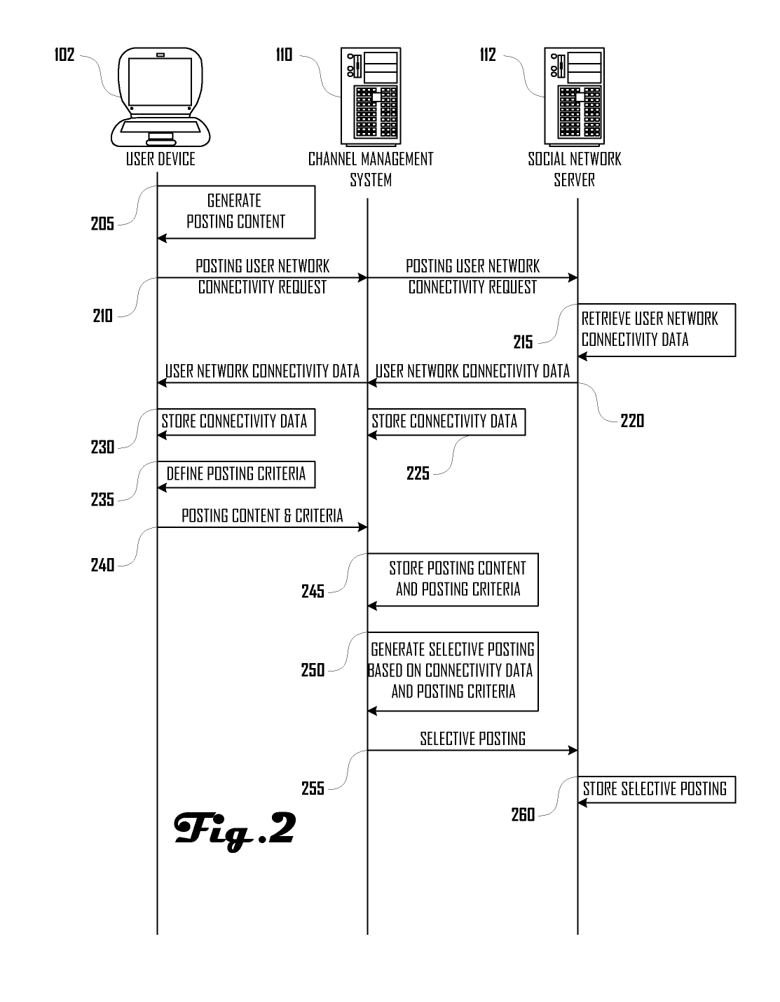

FIG. 2 is an exemplary data flow diagram illustrating an embodiment of a data flow path between the user device 102, social network server 112, and channel management system 110 of FIG. 1. The data flow begins where the user device 102 generates posting content at 205. For example, posting content may include a text message, an image, a video or the like, and generating posting content may include selecting or formatting a desired posting or indicating items for a desired posting.

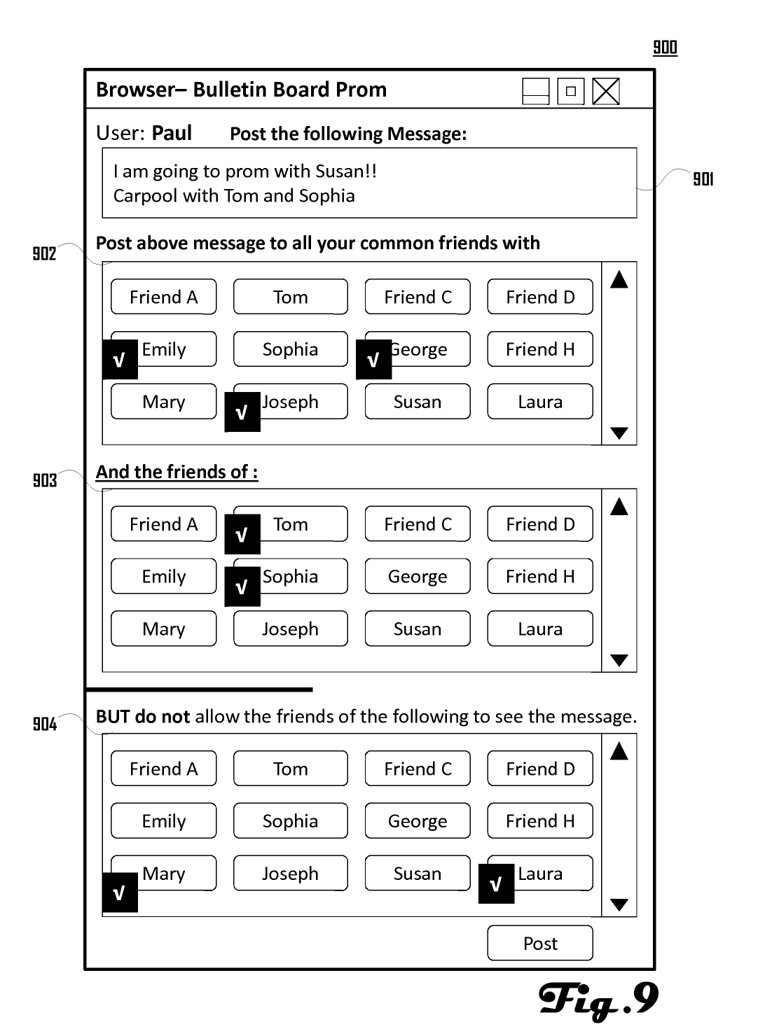

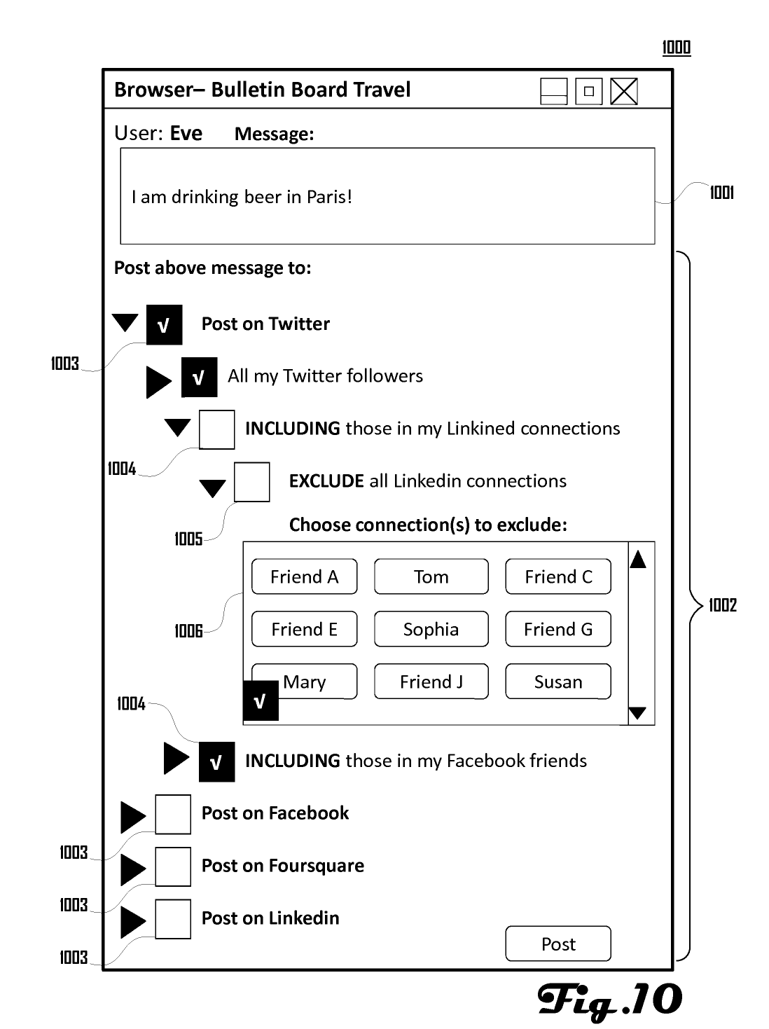

In various embodiments, a user interface allows a user to upload a picture, type text for a message, provide a link to posting content, or the like. For example, as discussed further herein, FIGS. 9 and 10 depict a user interface 900, 1000 that comprises a posting content text field 901, 1001 that allows a user to input text that will comprise a desired posting.

Returning to FIG. 2, a posting user network connectivity request is sent to the channel management system and to the social network server 112 at 210. Posting user network connectivity data is retrieved at 215 and posting user network connectivity data is sent to the channel management system 110 and to the user device 102 at 220, where it is stored at 225 and 230.

For example, in various embodiments, a user may desire to control the distribution of, or access to, the posting content that is generated at 205. This posting control can be applied to one or more user profiles of the user on one or more social networks. Accordingly, although a single social network server 112 is depicted in FIG. 2, it should be appreciated that there may be communications with a plurality of social network servers 112 in some embodiments. To control the distribution of, or access to, the posting content that is generated at 205, it may be necessary to obtain data regarding the posting user's connectivity to other users across one or more social networks. The posting user may have one or more profiles on one or more social networks, and the posting user may be associated with one or more users or user profiles across one or more social networks (e.g., be “a friend”, “linked”, “a follower”, “followed by”, “a connection” or the like). Additionally, these users may also be associated with one or more further users or user profiles across one or more social networks.

Posting user network connectivity data may include data regarding how the posting user is connected to other users or user profiles on various social networks. This data may include degree of connectivity to user profiles or degree of connectivity to a user with one or more user profiles across a plurality of social networks. For example a posting user may have a Facebook and Twitter account and be friends with user profile “Smithy” on Facebook and be followed by user profile “KSmith” on Twitter. Both of these accounts may be associated with person “Kyle Smith.” Accordingly, posting user network connectivity data can include an indication of connectivity to user profiles “Smithy” and “KSmith,” but also indicate connectivity to the person “Kyle Smith” across both social networks. Network connectivity and network connectivity data are described in further detail herein.

Additionally, a posting user network connectivity request may be sent automatically without user interaction or may be done on user request. For example, when a user logs onto an interface or begins to generate posting content in 205, a posting criteria input portion may need to be updated to reflect the current state of user connectivity or the current state of users or user profiles associated with the posting user. Frequently updating and refreshing posting user network data may be desirable in various embodiments, because user and user profile connectivity across social networks is dynamic and can change rapidly.

In some embodiments, posting user network connectivity data may be obtained at a user device 102 directly from a social network server 112 without the channel management system 110 as an intermediary; may be obtained from user network connectivity data stored at the channel management system 110; may be obtained from user network connectivity data stored at a data source provider server 113 (FIG. 1); or may be obtained from user network connectivity data stored at the user device 102 itself.

Additionally, in various embodiments, the user device 102 and/or the channel management system 110 may be configured to obtain or request updated user network connectivity data at various desirable intervals. Additionally, the social network server 112 or data source provider 113 may be configured to obtain and send updated user network connectivity data at various desirable intervals.

Returning to the data flow of FIG. 2, at 235 posting criteria are defined and posting criteria and posting content are sent to the channel management system 110 at 240, where the posting criteria and posting content are stored. As described in more detail herein, posting criteria may include an indication of permissions or restrictions on access to, or distribution of, the selected posting content in a posting. For example, a posting user may desire to restrict distribution or notification of the posting content, and may indicate one or more users or user profiles of a social network restricted from viewing, receiving a notification about, or being sent the posting content in a posting. Similarly, a posting user may desire to allow distribution or notification of the posting content, and may indicate one or more users or user profiles of a social network authorized for viewing, receiving a notification about, or being sent the posting content in a posting.

Posting criteria can include any suitable rules related to posting user network data, or other suitable information. For example, posing criteria can include a rule regarding users or user profiles with first degree, second degree, third degree connections, or the like.

Returning to the data flow, a selective posting based on connectivity data and posting criteria is generated at 250 and the selective posting is sent to the social network server 112 at 255, where the selective posting is stored at 112. In some embodiments, a selective posting may be a posting that modifies default access, distribution, or notification attributes of one or more social networks. In further embodiments, a selective posting may be a posting where access, distribution, or notification attributes are selected on one or more social networks.

For example, referring to the “Kyle Smith” example above, the posting user may define posting criteria that prohibits user “Kyle Smith” from receiving notification of, distribution of, or access to a message generated by the posting user. Accordingly, the channel management system 110 may generate a selective posting for both the posting user's Facebook and Twitter accounts, wherein the posting permissions are appropriately set for “Kyle Smith.” Specifically, “Kyle Smith” would be blocked via his “Smithy” Facebook profile, and blocked via his “KSmith” Twitter account.

In various embodiments, a social network may have default posting criteria for postings, and a selective posting may modify this default posting criteria. For example, when a user posts a message on Facebook, the default posting criteria may be to send the posting to all first-degree friends of the posting user. However, in some embodiments, the user may generate a selective posting that changes the default and is more restrictive than this default, which may include sending the posting to all the first degree-friends of the posting user except for some selected first-degree friends. The user may also generate a selective posting that changes the default and is more inclusive than the default, which may include sending the posting to all the user's first and second-degree friends. Default posting criteria may be modified in any suitable way in accordance with various embodiments.

As discussed above, the user device 102 and/or the channel management system 110 may be configured to obtain or request updated user network connectivity data at various desirable intervals. The user device 102 and/or the channel management system 110 may further be configured to determine if the updated user network connectivity data violates any posting criteria or a generated selective posting that is stored or presented on a social network. In some embodiments, the channel management system 110, or social network server 112 may be configured to automatically update generated selective posting that is stored or presented on a social network so that it conforms to defined posting criteria.

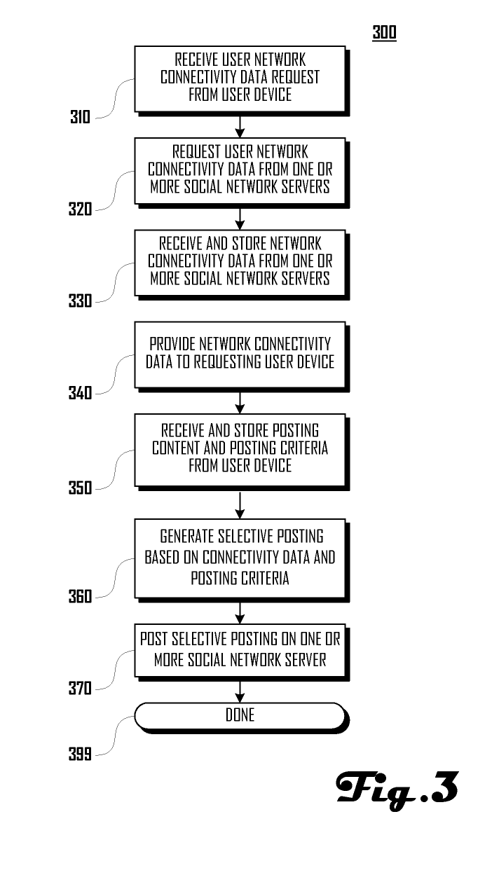

FIG. 3 is an exemplary block diagram illustrating an embodiment of a method 300 for social network posting management in accordance with an embodiment. The method begins in block 310 where a network connectivity data request is received from a user device 102 and in block 320, user connectivity data is requested from one or more social network serverss 112. In block 330, network connectivity data is received from one or more social network serverss 112 and stored. In block 340, the network connectivity data is provided to the requesting user device 102 and posting content and posting criteria is received from the user device 102 in block 350. In block 360, a selective posting based on connectivity data and posting criteria is generated, and the selective posting is posted to one or more social network serverss 112 in block 370. The method 300 is done at 399.

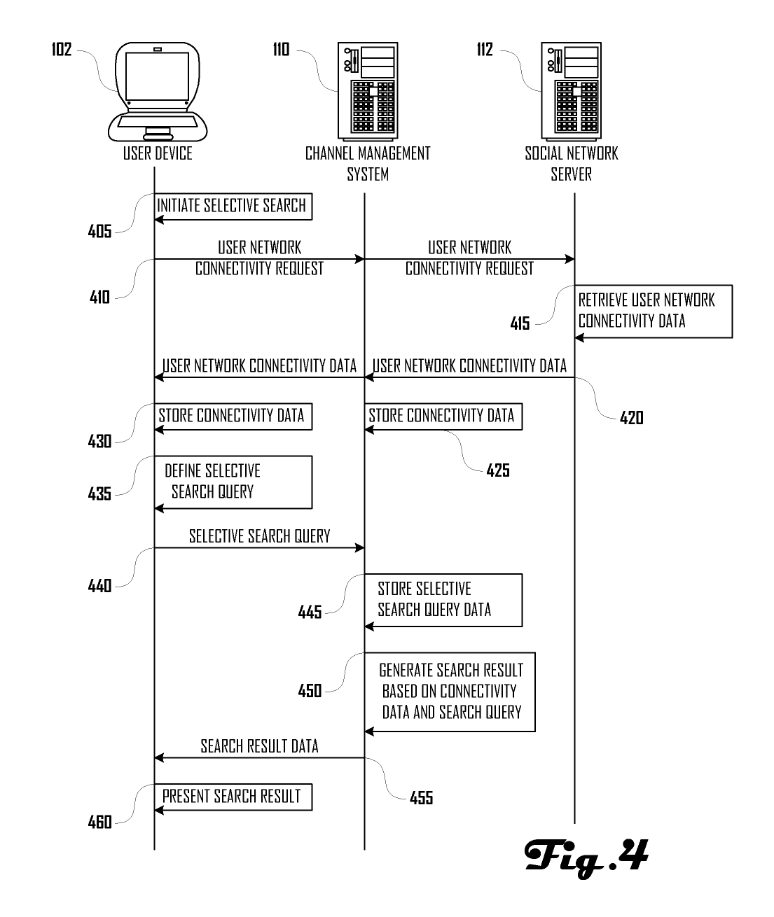

FIG. 4 is an exemplary data flow diagram illustrating an embodiment of a data flow path between the user device 102, social network server 112, and channel management system 110 of FIG. 1. The data flow begins at 405 where a selective search query is initiated and a user network connectivity request is sent to the channel management system 110 and social network server 112 at 410. The social network server 112 retrieves user network connectivity data at 415, and the user network connectivity data is sent to the channel management system 110 and user device 102 at 420, where it is saved at 425 and 430.

As described above in relation to FIG. 2, it may be desirable to obtain the most current information regarding a user's network connectivity in and among one or more social networks because social network connectivity can be dynamic. FIG. 4 depicts an embodiment wherein the user desires to make a search query related to the user's social network connectivity, and when initiating a search dialog, opening a search interface, or the like, the user's social network connectivity data from one or more social networks may be obtained so that the user can define a selective search query at 435 using the most current connectivity data.

In one example, a user on a dating social network may want to only search for other users on the dating website who are not associated with one or more person that the user is currently dating (so that the user does not contact or attempt to date persons who would inform the user's current dating partners). Accordingly, the user may desire to generate a search query that excludes or annotates search results of user profiles that belong to persons the user is dating; first degree connections to persons that the user is dating; and/or second degree connections to persons that the user is dating.

Returning to the data flow of FIG. 4, the selective search query is sent to the channel management system 110 at 440, where the selective search query is stored at 445. The channel management system 110 generates a search result based on connectivity data and the search query data at 450, and sends the search result data to the user device 102 at 455 where the search results are presented at 460.

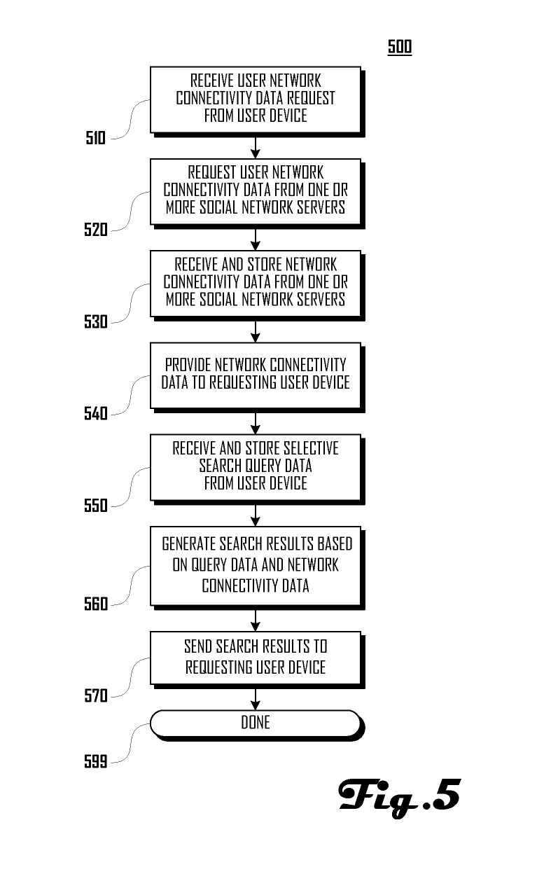

FIG. 5 is an exemplary block diagram illustrating an embodiment of a method 500 for social network search query management in accordance with an embodiment. The method 500 begins in block 510 where a user network connectivity data request is received from a user device 102. User network connectivity data from one or more social media network servers 112 is requested in block 520 and in block 530 network connectivity data is received from one or more social media servers 112 and stored. In block 540, the social network connectivity data is provided to the requesting user device 102. In block 550, selective search query data is received from the user device 102 and stored. Search results based on query data and network connectivity data are generated in block 560. The search results are sent to the requesting user device 102 in block 570 and the method 500 is done is block 599.

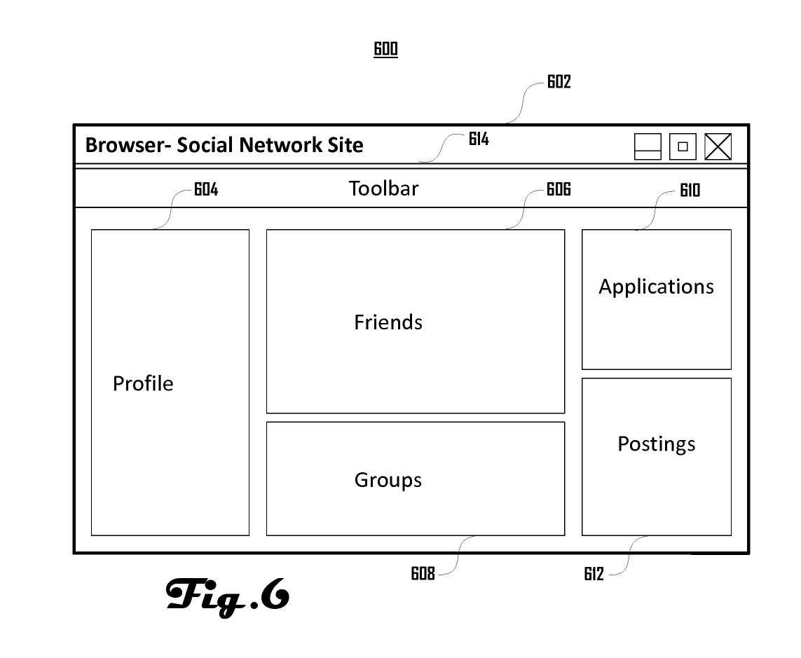

FIG. 6 is a diagram showing an illustrative user interface 600 for a social network service. According to certain illustrative embodiments, a browser window 602 may display a toolbar 614, a profile section 604, a friends section 606, a groups section 608, an applications section 610, and a postings section 612.

A typical browser window 602 allows a user to interact with various applications over the Internet. One such type of application is a social network service or social network server 112 as described herein. Through the web browser 602, a user may create and access an account with a social network server 112. The web browser 602 may then display to the user a number of features associated with the social network service. The web browser 602 may also allow the user to send information to the server 112.

A typical social network service allows a user to enter information about the user to create a profile 604. The profile 604 may then be displayed when a user accesses the service. The profile 604 information may include, but is not limited to, contact information, interests, hobbies, career, and other personal items. As mentioned above, this information may be either public or limited to a select few as determined by the user.

A social network service generally allows a user to make connections with other users. The other users may include friends, family, coworkers and various professional relationships. These connections are classified as “friends” according to some social network services. Through the web browser 602, a user may search for user profiles, view user profiles, and generate content for the profiles of the user's friends, and the like. The user may be able to view photos, comments, and status updates associated with those friends, which may be displayed in the friends section 606.

The web browser 602 may be configured to display a number of groups that a user has chosen to join in a group field 608. Groups may be created by users for a variety of purposes. As mentioned above, groups may be formed based on situations or events. Through the group section 608, a user may interact with a particular group and receive updates and instructions relating to his or her position within the group.

The web browser 602 may also display, in an applications field 610, a number of applications associated with the social network service. These applications may either be created by the social network service developers or third party developers. These applications may include games and other services which social network users may find beneficial or enjoyable. In certain embodiments, an application may be used to gather specific information and provide the information to the channel management system 110. For example, if a user makes a connection (e.g., a new “friend”), an application may send that data to the channel management system 110. Additionally, the user device 102 or channel management system 110 may also be configured to periodically request or otherwise obtain updates of the user's network connectivity data.

In various embodiments, social network sites, in a posting field 612, allow users to make postings of notes and blogs and other information. These postings may be public or limited to specific friends associated with a user. As with other information associated with a user, text within the postings may be provided to the channel management system 110 to determine if it may be beneficial to enhancing the performance of the channel management system 110.

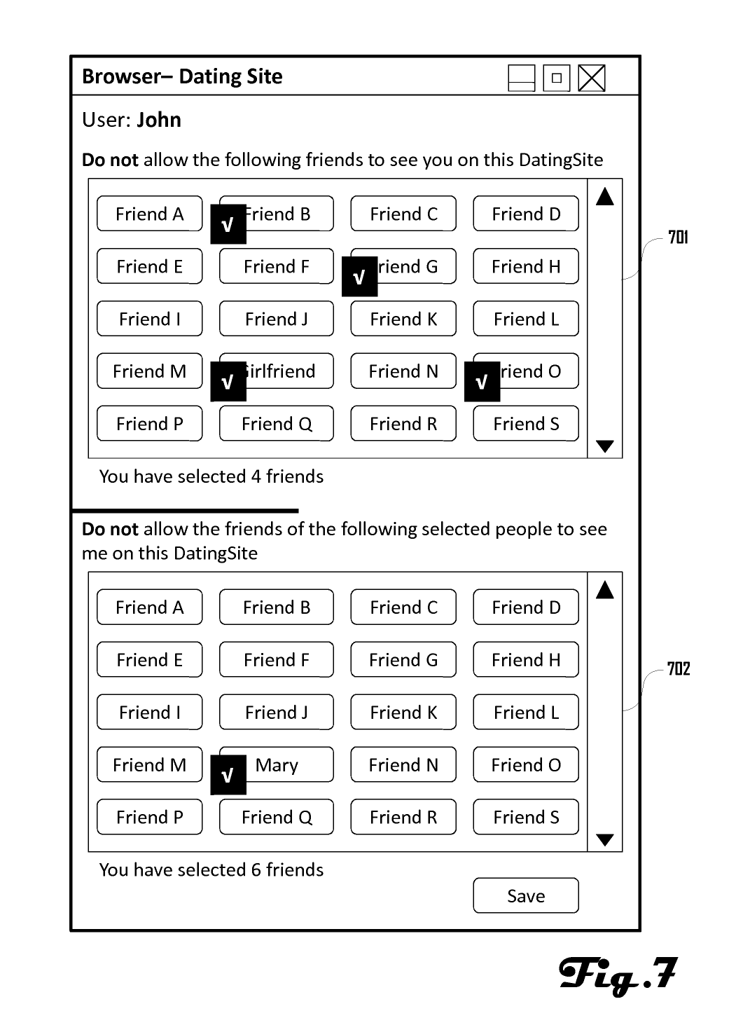

FIGS. 7-10 depict user interfaces 700, 800, 900, 1000 on a user device 102 for communicating with a channel management system 110 and/or a social network server 112 in accordance with an embodiment. The depicted interfaces 700, 800, 900, 1000 are not exhaustive of possible interfaces and should not be construed to limit the scope of the present disclosure. User interfaces in accordance with the present disclosure can be customized to suit the needs of various user and functionalities of a channel management system 110 and/or a social network server 112.

FIG. 7 is a diagram showing an illustrative user interface 700 used in an online dating service. In this embodiment, the interface 700 may comprise an inclusion field 701 and an exclusion field 702. For example, a user “John” can select which of his friends to be excluded from access to his dating profile on the dating website, and which group of his friend's friends, (the friends of his girlfriend in this case), are to be excluded from viewing John's profile on the dating site.

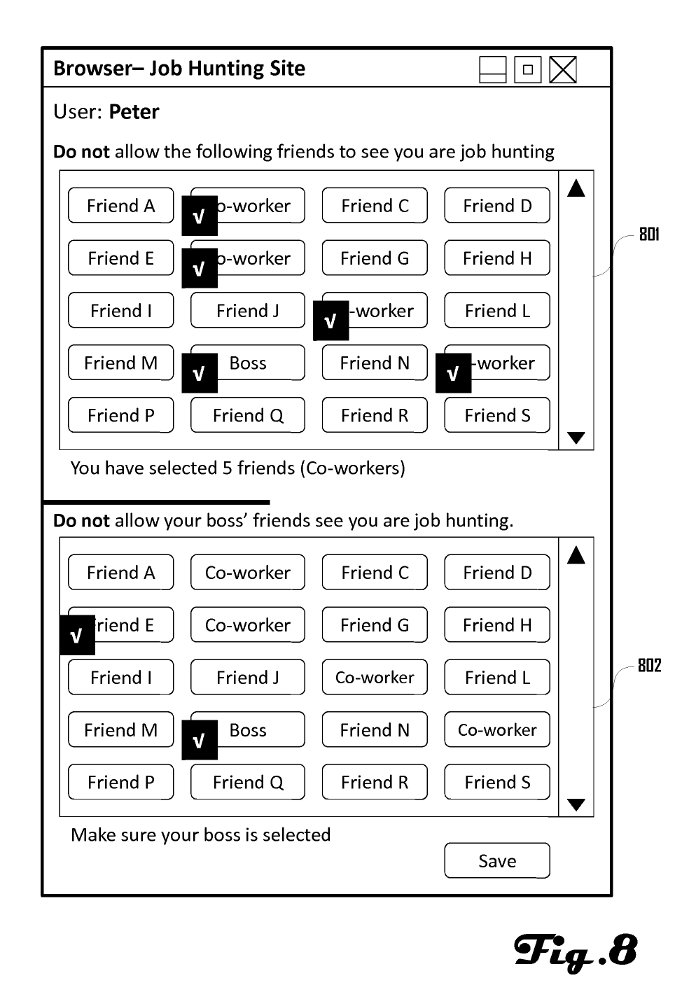

FIG. 8 is a diagram showing an illustrative user interface 800 that may be used in an online job search service or social network. The interface 800 may include an inclusion field 801 and may include an exclusion field 802. For example, a user “Peter” can select which of his business contacts (co-workers in this case), to have access to his job hunting profile in the inclusion field 801. “Peter” may also select which of his boss' friends to be excluded from viewing Peter's online job application or job hunting profile via the exclusion field 802.

FIG. 9 is a diagram showing an illustrative user interface 900 which may be used in an online bulletin board or bulletin board social network. For example, the interface may comprise a message field 901, a first degree inclusion field 902, a second degree inclusion field, and an exclusion field 904. For example, after composing a message in the message field 901, a user “Paul” can decide to post the message to all the common friends he has with some selected people in the first degree inclusion field 902 and to post the message to all the friends of some other selected people in the second degree inclusion field 903, but to not post to the friends of some selected users defined in the exclusion field 904.

FIG. 10 is a diagram showing an illustrative user interface 1000 that may be used in an online bulletin board that requires access to user profiles across different social networks. For example, the interface 1000 may comprise a message field 1001 and a criteria definition hierarchy 1002. The criteria definition hierarchy 1002 may comprise a plurality of social network selection fields 1003 (e.g., Twitter, Facebook, Foursquare and LinkedIn are depicted). Each selection field 1003 may be expandable, and in FIG. 10 the “Twitter” selection field 1003 is shown expanded and comprising inclusion selection fields 1004, an exclusion selection field 1005 and an exclusion selection box 1006.

For example, user “Eve” can select to post in one or more social networks and in this example, Twitter is selected by the check mark in the “Twitter” social network selection field 1003. Additionally, “Eve” may also exclude the users or user profiles that also belong to another social network from viewing the message via the exclusion field and box 1005, 1006. “Eve” can define criteria for inclusion and/or exclusion for users (some with multiple profiles across the social networks) or for user profiles on a social network.

The selection and instructions given by a user, as shown in the example in FIGS. 7-10 may be used to define posting criteria (see e.g., FIG. 2 at 325). In various embodiments, such criteria or posting criteria can be translated into logical instructions by an operation reader. The posting criteria may contain, and/or draw reference to, a list of people who are directly connected to the user (i.e., “first-degree connections”), a list of people who are connected to the first-degree connections of the user (i.e., “second-degree connections”), and a list of people who are connected to the second-degree connections of the user (i.e., “third-degree connections” or “higher-degree connections”), and so forth. In various embodiments, criteria may comprise inclusion or exclusion of first-degree connections of a user, second-degree connections of a user, or the like.

In some embodiments, a given user with multiple profiles across a plurality of social networks may have different connectivity degrees to a posting or searching user on each social network. For example, a posting user may be directly connected with or first-degree friends with user profile “DaveBot2000” on an XBox social network and may be a second degree connection with user profile “D. Lee” on LinkedIn. Both profiles may belong to user “Dave Lee.”

Various criteria may be configured to handle this different status on different social media networks in a desired way. For example, exclusionary criteria that blocks first degree connections such as “DaveBot2000” may also block “D. Lee” on LinkedIn despite only being a second degree connection on that social network.

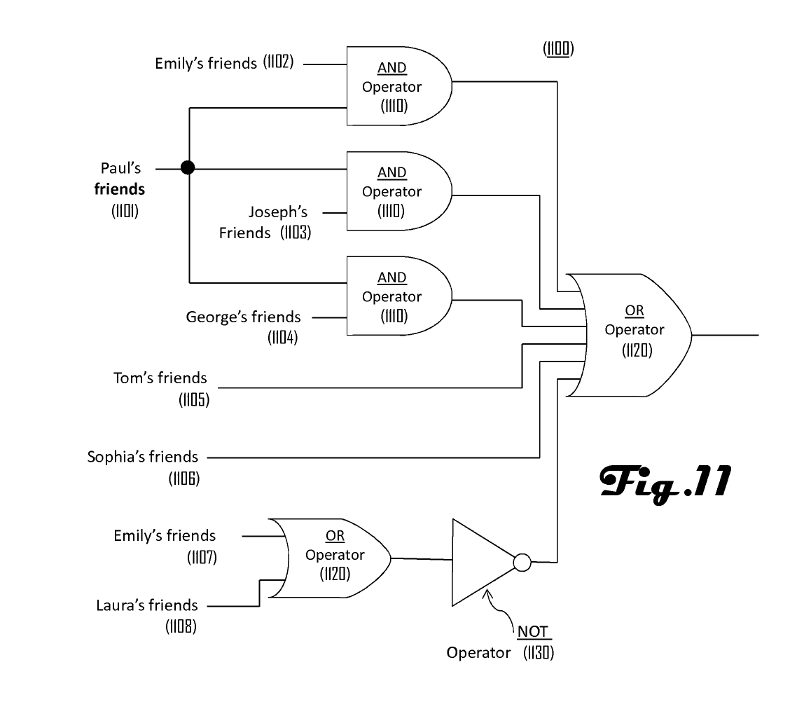

FIG. 11 is an example of translation and formulation of logical instructions by an operation reader 1100. For example, suppose user Paul 1101 above wants to post a message that can be viewed by people who meet these criteria: #1—Paul's common friends with Emily 1102, Joseph 1103 and George 1104, #2—friends of Tom 1105 or Sophia 1106, and #3—but not friends of Emily 1107 or Laura 1108. The operation reader can translate that criteria to logical instructions involving three AND operators 1110, two OR operators 1120 and one NOT operator 1130.

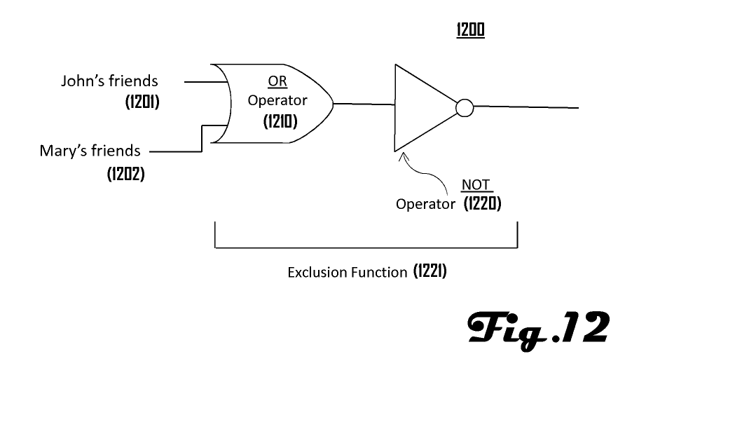

FIG. 12 is another example of a translation and formulation result from an operation reader 1200. For example, suppose user John 1201 (as discussed above) wants to search for people on a dating site who meet these Criteria: #1—NOT John's friend, #2—NOT his girlfriend Mary's 1202 friends. The operation reader can translate that criteria to logical instructions involving one OR operator 1210 and one NOT operator 1220. The combination of the OR operator 1210 and NOT operator 1220 forms an exclusion function 1221, a specialized form of logical instruction.

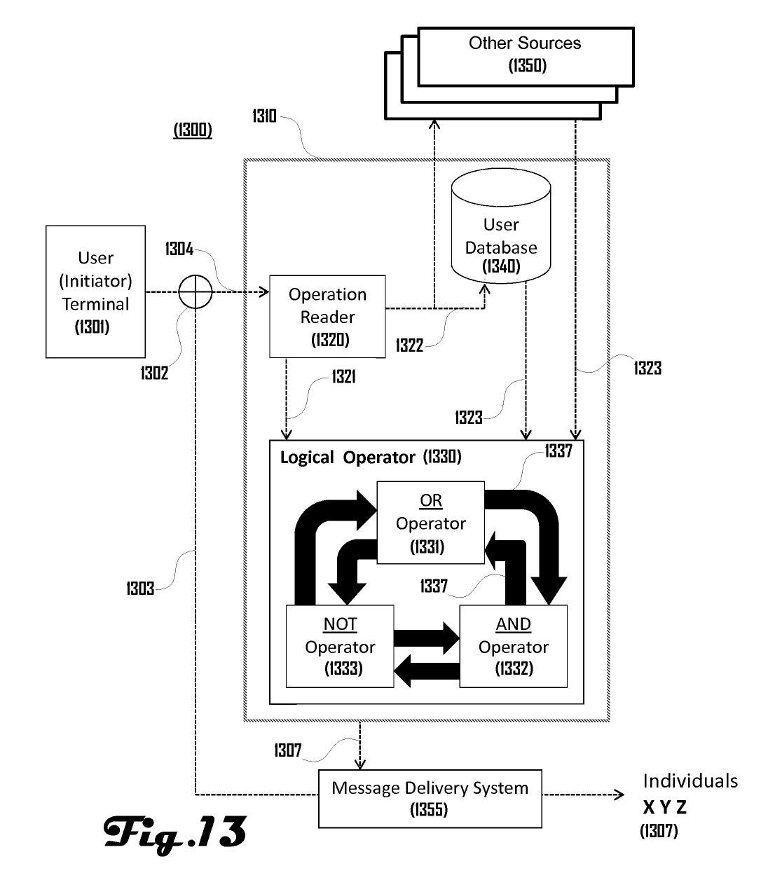

FIG. 13 is a diagram showing an illustrative presentation of a process 1300 of a channel management system 110. A user of the methods and system of the present disclosure (e.g., an “initiator” 1301) can be connected, via a computer network 104 (FIG. 1), to the channel management system 110 (e.g., via the user device 102). The initiator may want to send a message (including, but not limited to, text messages, photos, audio/video clips, and files; postings on online bulletin boards) or establish a connection to an individual or a group of individuals. In this example, the initiator's action is composed of the main body of the message (it may be a message or a connection request, referred to in this example as “Main Body” 1303) and the criteria of the action. The criteria of the action may include instructions and conditions for delivery of the main body 1303; for example, the user may request “send this message to my friends or friends of Betty” or “connect me to individuals who are not my friends or not friend of Charles” (referred to in this example as “Criteria” 1304). A message separator 1302 can separate the criteria 1304 from the main body 1303 of the message.

In this example, an operation reader 1320 analyzes the criteria 1304. The operation reader 1320 may receive the criteria from a number of sources including a user, a group of users, an organization, Web sites, social networks and/or specialized applications. The criteria include pre-defined or user-defined, pre-generated or real-time-generated instructions identifying the instructions, and individuals and groups as the target recipient of the main body 1303. The criteria may take the form of separate instructions accompanying the main body 1303, or as codes embedded in the main body.

The operation reader 1320 formulates the criteria into instructions for logical operations (referred to in this example as “logical instructions” 1321).

The operation reader 1320 also identifies and accesses the information of the individuals relating to the criteria 1322 from a user database 1340 and/or from other sources 1350, including, but not limited to, social networks, membership databases, gaming networks, etc. In addition, the operation reader 1320 may request and receive data from other data sources, such as news sites, online media and customized applications. For example, in FIG. 12, John's friend list, and Mary's friend list can be retrieved from the online social network Facebook.

The individuals' information 1323 retrieved from the user database 1340 and other sources 1350 is analyzed, organized and filtered at the logical operator 1330 according to multiple sets of logical rules defined in the logical instructions 1321. In various embodiments, the main functions of the logical operator are to perform the OR operator 1331, the AND operator 1332 and the NOT operator 1333, on the identified individuals as according to the logical instructions 1321. The OR, AND and NOT operators 1331, 1332, 1333 can be used in combination and in permutation to handle all logical instructions 1321 possible.

As the criteria 1304 could compose complex and interrelating logical instructions 1321, the selected individuals from the user database and other sources 1323 may go through the OR 1331, AND 1332 and NOT 1333 operators in combination and in multiple iterations 1337 in the logical operator.

It is then determined from the output of the logical operator which individuals will be the recipient of the main body 1303.

The resulting identified individuals 1307 from the logical operator will be passed to a message delivery system 1355, either operating as part of the channel management system or separately operated by a third-party, to establish channels between the initiator 1301 and the identified individuals 1307. The main body 1303 will then be passed from the initiator 1301 to the selected individuals generated by the logical operator 1307.

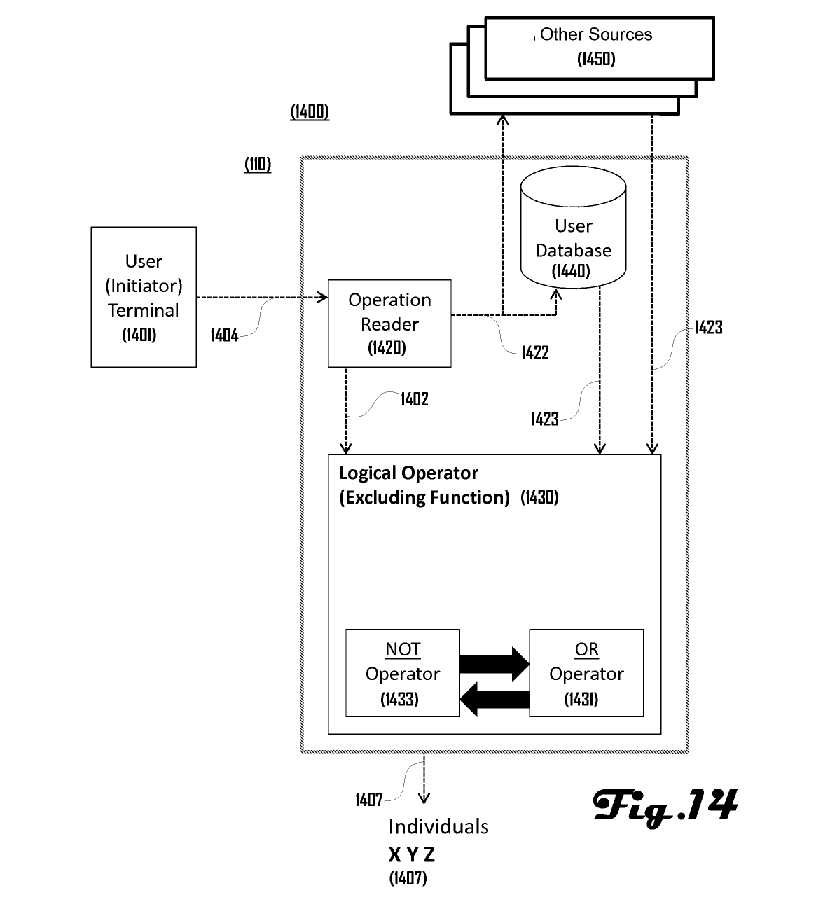

FIG. 14 is a diagram showing an illustrative embodiment of a process that a channel management system 110 may use for exclusion in matching services such as dating services and job-search services. (See e.g., FIGS. 7 and 8) The user of the methods and systems of the present disclosure (referred to in this example as “initiator” 1401) can be connected, via a computer network 104, to the channel management system 110 (FIG. 1). The initiator may want to browse the user database, search for individuals or to establish a connection with an individual or a group of individuals that matches a certain criteria 1404, such as gender, location, age group, etc., (the inclusion rules of the criteria 1404). Furthermore, the initiator 1401 may want to be mutually hidden from a certain individual or a group of individuals (exclusion rules of the criteria 1404) on the matching services. For example, the user may request a criteria 1404 that contains the inclusion rules “find female aged 20 to 30 who lives within 10 miles from me” and exclusive rules “hide my dating profile from my girlfriend and all her Facebook friends.” Together, the inclusion rules and exclusion rules form an integral part of the Criteria 1404 in the process described in FIG. 14.

In this example, an operation reader 1420 analyzes the criteria 1404. The operation reader 1420 may receive the criteria 1404 from a number of sources including a user, a group of users, an organization, a Web sites, social networks and/or specialized applications. The criteria 1404 may include pre-defined or user-defined, pre-generated or real-time-generated instructions.

The operation reader 1420 formulates the criteria 1404 into instructions for logical operator 1430 to implement the inclusion rules and exclusion rules of the criteria 1404. (“logical instructions” 1402)

The operation reader 1420 also identifies and accesses the information of the individuals relating to the criteria 1422 from the user database 1440 and/or from other sources 1450, including, but not limited to, social networks, membership databases, gaming networks, etc. In addition, the channel management system 110 may request and receive data from other data sources, such as news sites, online media and customized applications.

The individuals' information is retrieved from the user database and other sources 1423 according to the criteria 1404 and will be passed to the logical operator 1430. The individuals' information retrieved from the user database and other sources 1423 is analyzed, organized and filtered at the logical operator 1430 according to the multiple set of logical rules defined in the logical instructions 1402, which, in this example, consists mainly of NOT Operator 1433 and OR operator 1431; the AND operator in the logical operator is not utilized in this example. The OR and NOT operators 1431, 1433 can be used in combination and in permutation to handle all criteria 1404 possible.

As the criteria 1404 could refer individuals and groups in a number of social networks, the selected individuals from the user database 1440 and other sources 1450 may go through the logical operator 1430 in multiple iterations.

It is then determined from the output of the logical operator 1430 which individuals will be matched to the initiator 1401. The resulting identified individuals 1407 from the channel management system 1410 will be presented to the initiator 1401, either performed by the channel management system 1410 or by a third-party system.

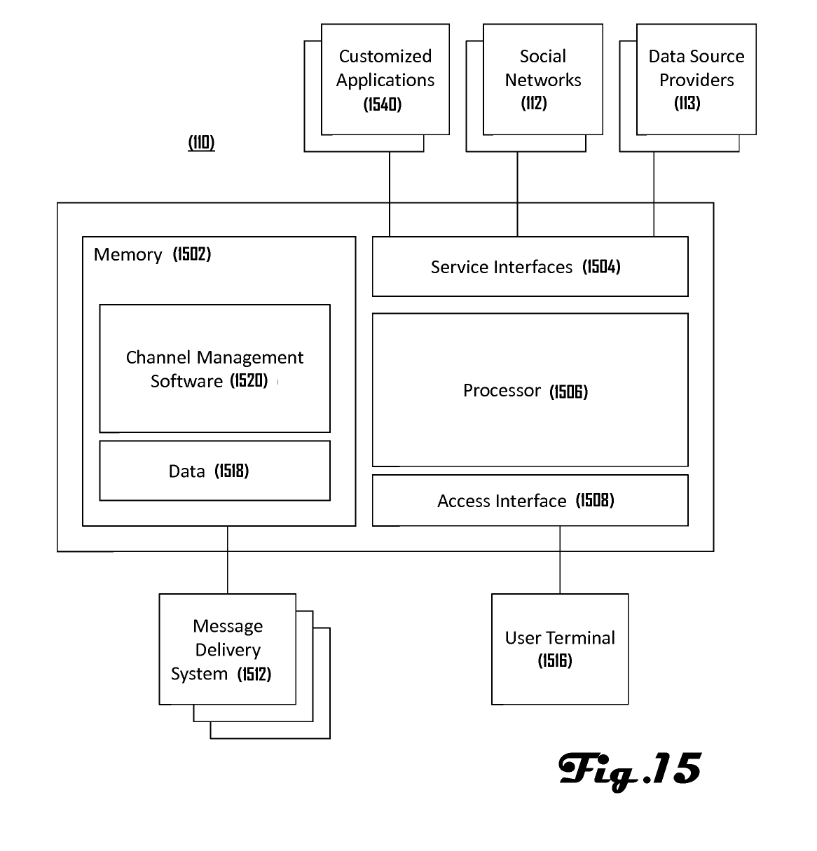

FIG. 15 is a diagram showing an illustrative channel management system 110 in accordance with one embodiment. The channel management system 110 may include a memory 1502 having channel management software 1520 and data 1518 stored thereon. The channel management system 110 may further include service interfaces 1504 for interfacing with data source providers 113 and social networks 112, a processor 1506, and an access interface 1508 allowing users to access the system. The channel management system 110 may also make use of a message delivery system 1512.

Many types of memory 1502 exist and may be used in conjunction with the channel management system 110. Some types of memory, such as hard disk drives, optical disc drives, solid state drives, and other nonvolatile memory, are optimized for storage. Other types of memory, including volatile memory such as Random Access Memory (RAM), are optimized for speed and can be used as “working memory” for providing executable instructions to the processor 1506. The various forms of memory may store information in the form of data 1518 and software 1520. In certain embodiments, the memory 1502 includes both nonvolatile and volatile memory. Software 1520 may be defined as a set of instructions for the processor 1506 which are stored in some form of memory 1502. The software may be configured to instruct the processor 1506 to perform functions relating to the management of social network groups.

The service interfaces 1504 may provide the channel management system 110 with access to various data source providers 113 and social networks 112 through a network such as the Internet or wireless data network 104 (FIG. 1). Data source providers 113 may include, but are not limited to, social networking services, online news services, a blogging service or website, location-based information, a micro-blogging service (e.g., Twitter) or website, and customized source providers. Social networks 112 may include, but are not limited to, social networking services such as Facebook, Twitter, LinkedIn, traditional organizations, or location-based information sharing services such as Foursquare, etc. The channel management system 110 may be configured to retrieve specific data 1518 from these data source providers 113 and social networks 112 to use for analysis.

The access interface 1508 may be used to provide a user or administrator with access to the channel management system 110. A user or administrator may access the system through a user terminal 1516. In certain embodiments, the user terminal 1516 may include peripheral input or output devices communicatively coupled to the processor 1506. Additionally or alternatively, the user terminal 1516 may include a number of separate computing devices communicatively coupled to the processor 1506 through a network. Such separate computing devices may include, but are not limited to, personal desktop computers, portable computers, and mobile hand-held devices such as cellular phones, smart-phones and Personal Digital Assistants (PDAs).

The Message Delivery System 1512 may provide a means to store, deliver and/or redirect messages. In certain embodiments, the channel management system 110 may be configured to translate the retrieved data 1518 from the data source providers 113 and social networks 112 into a format able to be processed by message delivery system 1512.

The present example illustrates the message delivery system 1512 as external to and communicatively coupled to the processor 1506 of the channel management system 110. Nevertheless, it should be understood that in certain embodiments some or all of the functionality of the rule-based system may be performed by the same processor 1506 executing the channel management software 1520. For example, in certain embodiments the message delivery functionality may be incorporated directly into the channel management software 1520 such that the processor 1506, by executing the channel management software 1520, also implements the message delivery system 1512.

In certain embodiments, the channel management system 110 may receive information from a number of social networks 112. Several social networks 112 are available which allow users to network and communicate with friends, family, and coworkers. These social network sites 112 may include, but are not limited to, Facebook, LinkedIn, MySpace, Foursquare and Twitter. Such social network sites 112 allow users to announce their status either publicly or to only those they have selected as friends. A friend on a social network site 112 may not be limited to the traditional definition of friend. A friend on social networks 112 may include family, coworkers, professional relationships and relationships between organizations.

In some embodiments, the channel management system 110 may be configured to receive and analyze data from customized applications 1540. Customized applications 1540 may include any type of service which provides data. In some embodiments, an application may be designed specifically for collecting and providing data to the channel management system.

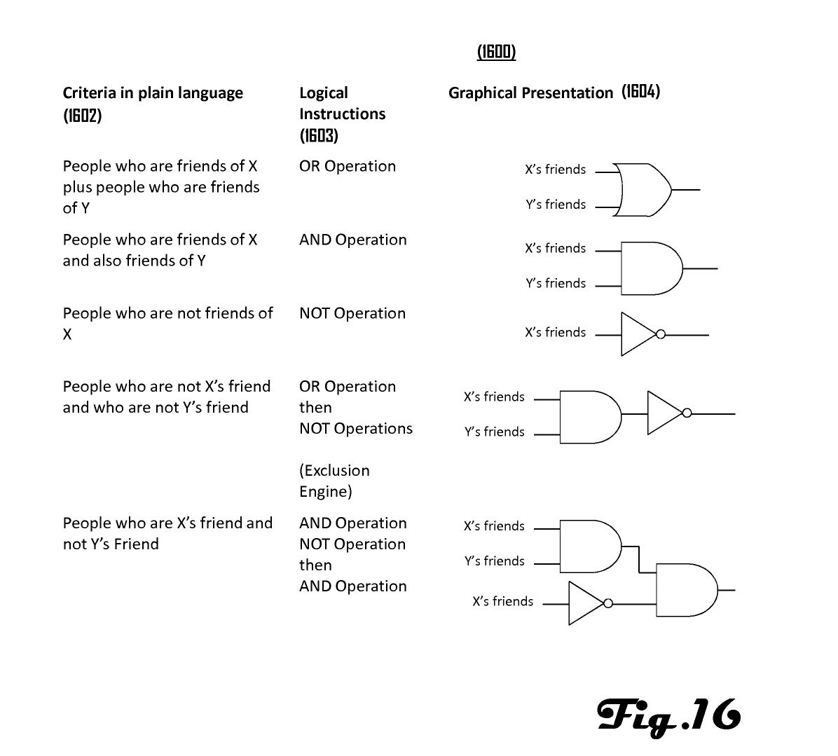

FIG. 16 is a table showing illustrative examples 1600 for conversion of the Criteria 1602 to logical instructions 1603 and the graphical representation 1604 as used in FIG. 11 and FIG. 12.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In various embodiments, any of the steps can be performed automatically without user interaction.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A method for social network management comprising:
receiving first network connectivity data associated with one or more posting user profiles;
receiving posting content associated with one or more of the posting user profiles;
receiving posing criteria associated with the posting content and at least one of the posting user profiles;
generating a selective posting for at least one of the one or more posting user profiles, the selective posting having access or distribution properties different than a default posting and generated based on the posting criteria and the first network connectivity data; and
implementing the selective posting for at least one of the posting user profiles.

2. The method of claim 1, further comprising determining if the first network connectivity data has changed.

3. The method of claim 2, further comprising determining if a change in network connectivity conflicts with the posting criteria, and if so, modifying the implemented selective posting so that it complies with the posting criteria.

4. The method of claim 1, wherein posting content comprises at least one of: a user profile, an image, a video, and text.

5. The method of claim 1, wherein the posting content is associated with a plurality of posting user profiles.

6. The method of claim 1, wherein the one or more posting user profiles are social network user profiles.

7. The method of claim 1, wherein generating the selective posting comprises:
comparing the first network connectivity data to the posting criteria and modifying default access or distribution properties of a default posting to generate a selective posting such that the modified default access and distribution properties satisfy the posting criteria applied to the first network connectivity data.

8. The method of claim 1, wherein generating the selective posting comprises restricting access to the selective posting for one or more selected users or user profiles.

9. The method of claim 1, wherein generating the selective posting comprises restricting access to the selective posting for one or more users or user profiles having a first degree connection to one or more selected users or user profiles.

10. The method of claim 1, wherein generating the selective posting comprises restricting access to the selective posting for one or more users or user profiles having a second degree connection to one or more selected users or user profiles.

11. The method of claim 1, wherein posting criteria are applied to a user having a user profile on a plurality of social networks.

12. The method of claim 1, wherein the posting criteria are different for a first and second social network.

13. The method of claim 1, wherein the posting criteria comprises default posting criteria for a first social network and posting criteria different than a default posting criteria for a second social network.

14. The method of claim 1, wherein the posting criteria comprises allowing access or distribution of posting content to users or user profiles that have a first degree connection to the posting user and first degree connections to one or more selected users or user profiles.

15. The method of claim 1, wherein the posting criteria comprises allowing access or distribution of posting content to users or user profiles that have a first degree connection to one or more selected users or user profiles.

16. The method of claim 1, wherein the posting criteria comprises allowing access or distribution of posting content to users or user profiles that have a second degree connection to one or more selected users or user profiles.

17. The method of claim 1, wherein generating the selective posting comprises analyzing the first network connectivity data with a logical operator module implementing the posting criteria.

18. The method of claim 17, wherein the logical operator module comprises AND, NOT and OR operators.

19. The method of claim 1, further comprising providing the received first network connectivity data to a user device.

20. The method of claim 19, wherein the posting criteria and posting content are received from the user device.

21. The method of claim 1, wherein a portion of the first network connectivity data is received from one or more social network servers.

22. The method of claim 1, wherein a portion of the first network connectivity data is received from one or more data source provider servers.

23. A computer system for social network management configured to perform the method of claim 1.

24. A method for social network searching, the method comprising:
receiving first network connectivity data associated with one or more searching user profiles;
receiving selective search query criteria associated with the at least one of the searching user profiles; and
generating search query results for at least one of the one or more posting user profiles, the search query results generated based on the selective search query criteria and the first network connectivity data.

25. The method of claim 24, further comprising providing the received first network connectivity data to a user device.

26. The method of claim 25, wherein the selective search query criteria is received from the user device.

27. The method of claim 25, further comprising providing the search results to the user device.

28. The method of claim 24, wherein the first network connectivity data is received from one or more social media servers.

29. The method of claim 24, wherein the first network connectivity data is received from one or more data source provider servers.

30. The method of claim 24, wherein generating the search query results comprises:
comparing the first network connectivity data to the selective search query criteria and determining if the selective search query criteria applies to any users or user profiles defined by the first network connectivity data.

31. The method of claim 24, wherein the selective search query criteria comprises excluding one or more users or user profiles having a first degree connection to one or more selected users or user profiles.

32. The method of claim 24, wherein the selective search query criteria comprises excluding one or more users or user profiles having a second degree connection to one or more selected users or user profiles.

33. The method of claim 24, wherein selective search query criteria are applied to a user having a user profile on a plurality of social networks.

34. The method of claim 24, wherein the selective search query criteria are different for a first and second social network.

35. The method of claim 24, wherein the selective search query criteria comprises including one or more users or user profiles having a first degree connection to one or more selected users or user profiles.

36. The method of claim 24, wherein the selective search query criteria comprises including one or more users or user profiles having a second degree connection to one or more selected users or user profiles.

37. The method of claim 24, wherein generating the search query results comprises analyzing the first network connectivity data with a logical operator module implementing the selective search query criteria.

38. The method of claim 37, wherein the logical operator module comprises AND, NOT and OR operators.

39. A computer system for social network searching operable to perform the method of claim 24.
